(19) United States
(12) Patent Application Publication
(10) Pub. No.: US 2016/0311066 A1
(43) Pub. Date: Oct. 27, 2016

(54) FLUX FOR BRAZING OF ALUMINUM ALLOYS

(71) Applicant: SOLVAY SA, Bruxelles (BE)

(72) Inventors: Placido GARCIA-JUAN, Bernburg (DE); Andreas BECKER, Lachendorf (DE)

(21) Appl. No.: 15/105,680

(22) PCT Filed: Dec. 17, 2014
(86) PCT No.: PCT/EP2014/078159

§ 371 Date: Jun. 17, 2016

Related U.S. Application Data
(60) Provisional application No. 61/918,012, filed on Dec. 19, 2013.

(51) Int. Cl. B23K 35/362; C22C 21/06; B23K 1/19; B23K 35/36; B23K 1/008

(52) U.S. Cl. CPC B23K 35/362; B23K 35/3605; B23K 1/008; B23K 1/19; C22C 21/06; B23K 2203/10

(57) ABSTRACT

Magnesium containing aluminum alloys can be brazed by using a flux mixture or a flux composition comprising a potassium fluoroaluminate which is essentially present as monopotassium tetrafluoroaluminate. The flux mixture or flux composition further contains a magnesium-compatibilizing agent, e.g. a cesium fluoroaluminate or potassium or cesium fluorozincates.

This application claims priority to U.S. provisional application No. 61/918,012, the whole content of this application being incorporated herein by reference for all purposes.

The present invention concerns a method and a flux suitable for brazing of aluminum alloys which contain magnesium.

U.S. Pat. Nos. 4,670,067 and 4,689,092 disclose mixtures for brazing of magnesium containing aluminum alloys. They contain cesium fluoroaluminate in admixture with aluminum fluoride or potassium fluoroaluminate.

EP-A 1466691 discloses the brazing of magnesium containing aluminum alloys using potassium fluorozincate of formula KₓZn_{y}F_{z} wherein x, y and z are positive integers. The heating of the parts to be brazed is performed according to a specific average temperature rising rate.

EP-A 1803525 discloses a method of brazing of magnesium containing aluminum alloys wherein a potassium fluoroaluminate is the main component. In that method, the incipient fluidization temperature of the filler material is equal to or maximally 15° C. higher than the incipient fluidization temperature of the flux.

Object of the present invention is to provide an improved method for brazing of magnesium containing aluminum alloys, especially those with a magnesium content of equal to or greater than 0.5% by weight. Another object is to provide a flux suitable for this purpose. These and other objects are achieved by the current invention.

The method of the present invention for brazing of magnesium containing aluminum alloys includes a step wherein a flux mixture containing potassium fluoroaluminate and at least one magnesium-compatibilizing compound selected from the group consisting of metal fluorometallates is applied with the proviso that potassium fluoroaluminate is essentially present as monopotassium tetrafluoroaluminate.

Another embodiment of the present invention provides flux mixtures suitable for brazing of magnesium containing aluminum alloys. The flux mixture of the present invention contains potassium fluoroaluminate and at least one magnesium-compatibilizing compound selected from the group consisting of metal fluorometallates with the proviso that potassium fluoroaluminate is essentially present as monopotassium tetrafluoroaluminate. Monopotassium fluoroaluminate is not considered in the present invention as being a member of the group of “metal fluorometallates”.

In the following, the flux mixture (and thus, also the brazing method according to the present invention using this flux mixture) is explained in detail.

The term “potassium fluoroaluminate” denotes the sum of KAlF₄, K₂AlF₅, K₃AlF₆ and their hydrates.

The term “essentially” preferably denotes that the potassium fluoroaluminate contains equal to or more than 97% by weight of monopotassium tetrafluoroaluminate, preferably equal to or more than 98% by weight, still more preferably equal to or more than 99% by weight. The terms “monopotassium tetrafluoroaluminate” and “monopotassium fluoroaluminate” are interchangeable in the context of the present invention.

The balance to 100% by weight in the “potassium fluoroaluminate”, if it is not constituted from 100% KAlF₄, is preferably constituted by K₂AlF₅ and/or its hydrates. The content of K₃AlF₆ in the “potassium fluoroaluminate” is preferably equal to or lower than 1% by weight, including 0% by weight.

The term “magnesium-compatibilizing” denotes compounds which, if applied together with potassium fluoroaluminates, improve the properties of potassium fluoroaluminates to join magnesium containing alloys by brazing; properties to be improved are, for example, wettability of the aluminum alloy surface and/or spreading of the filler metal. Preferred magnesium-compatibilizing metal fluorometallates are potassium or cesium fluorozincates and, preferably, cesium fluoroaluminates. Preferred potassium or cesium fluorozincates have the general formula KₓZnF_{y} or CsₓZnF_{y} wherein x and y are integers defined by 1≦x≦3, and y is 4≦x≦6 with the proviso that (x+3)=y. Compounds with several metallate centers, e.g. K₃Zn₂F₉ (=KZnF₄.K₂ZnF₅), can also be applied. The fluorozincates can be applied in the form of single compounds. For example, KZnF₄, K₂ZnF₅ or K₃ZnF₆, CsZnF₄, Cs₂ZnF₅ or Cs₃ZnF₆ can be applied as single compounds. It is also possible to apply mixtures containing two or more of these compounds.

As mentioned above, preferred compatibilizing compounds are selected from the group of cesium fluoroaluminates. The term “cesium fluoroaluminates” denotes compounds consisting of cesium, aluminum and fluorine (apart from undesired impurities). The general formula is CsₐAlF_{b} where a and b are integers defined by is 1≦x≦3, and y is 4≦x≦6 with the proviso that (a+3)=b. Preferred compounds are CsAlF₄, Cs₂AlF₅, Cs₃AlF₆, the respective compounds with several metallate centers, e.g. Cs₃Al₂F₉ (=CsAlF₄.Cs₂AlF₅), or mixtures of two or more of such cesium fluoroaluminates. CsAlF₄, optionally containing up to 5% by weight of Cs₂AlF₅ or Cs₃AlF₆, is the most preferred magnesium compatibilizer.

The compatibilizing compound is preferably present in the flux (relative to the sum of potassium fluoroaluminate plus compatibilizing agent set as 100% by weight) in an amount of equal to or greater than 1% by weight.

The compatibilizing compound is preferably present in the flux (relative to the sum of potassium fluoroaluminate plus compatibilizing agent set as 100% by weight) in an amount of equal to or lower than 20% by weight.

In view of the preferred embodiment, the presence of cesium fluoroaluminates, the content of cesium in the mixture composed of monopotassium fluoroaluminate and cesium fluoroaluminate, is preferably equal to lower than 10% by weight. In a flux mixture consisting of KAlF₄ and CsAlF₄, a content of 10% by weight of cesium corresponds to a content of 17.75% by weight of CsAlF₄ in the mixture. The content of cesium can even be higher than 10% by weight, but cesium compounds are expensive, and the costs may be higher than acceptable.

More preferably, the content of cesium in the flux mixture composed of monopotassium fluoroaluminate and cesium fluoroaluminate is equal to or lower than 5% by weight. Especially preferably, the cesium content is equal to or lower than 3.5% by weight of said composition.

Preferably, the content of cesium in the composition composed of monopotassium fluoroaluminate and cesium fluoroaluminate is equal to or greater than 1% by weight, more preferably, it is equal to or greater than 1.5% by weight, especially preferably, equal to or greater than 2% by weight in the flux mixture composed of monopotassium fluoroaluminate and cesium fluoroaluminate.

In the foregoing calculations, the use of the term “monopotassium fluoroaluminate” includes the presence of up to 3% by weight of K₂AlF₅, K₃AlF₆, their mixtures or hydrates. If monopotassium fluoroaluminate is present in the flux together with up to 3% by weight of said impurities as outlined further above, then the sum of monopotassium fluoroaluminate and these impurities is considered to constitute “monopotassium fluoroaluminate” for the sake of simplicity of the calculations.

The content of monofluoropotassium tetrafluoroaluminate in the flux mixture is preferably equal to or greater than 8% by weight, calculated on the total dry weight of the flux mixture. The content of monofluoropotassium tetrafluoroaluminate in the flux mixture is preferably equal to or lower than 99% by weight, calculated on the total dry weight of the flux mixture.

The monopotassium tetrafluoroaluminate, the cesium fluoroaluminates and potassium or cesium fluorozincates are known compounds and commercially available.

Monopotassium tetrafluoroaluminate can be prepared by reacting Al(OH)₃ and HF in a molar ratio of approximately 1:4, with subsequent neutralization with a KOH lye. The total molar ratio of K:Al:F is approximately 1:1:4.

Cesium fluoroaluminates can similarly prepared from Al(OH)₃, HF and CsOH solution. To produce CsAlF₄, the molar ratio of Cs:Al:F is approximately 1:1:4; to produce Cs₂AlF₅, it is approximately 2:1:5, and to produce Cs₃AlF₆, it is approximately 3:1:6. If desired, any ratios between 1:1:4 to 3:1:6 deliver suitable cesium fluoroaluminates.

Fluorozincates can, for example, be prepared as described in U.S. Pat. No. 6,743,409. Depending on the desired particle size, alkali metal hydroxide, zinc oxide and hydrofluoric acid are mixed, or hydrogen fluoride and zinc oxide are mixed and alkali metal hydroxide is added, or zinc oxide and hydrofluoric acid are mixed and alkali metal fluoride is added.

The above described mixtures of monopotassium tetrafluoroaluminate and compatibilizing compound which preferably is cesium tetrafluoroaluminate or potassium or cesium fluorozincate, can be used as such.

The mixtures mentioned above may additionally contain additives which improve the brazing process or the brazed product. For example, the flux mixture may contain solder metal (also called filler metal) or a filler metal precursor, for example, silicon, germanium or copper, or an alkali metal fluorosilicate. The amount of such filler metal or solder metal precursor, if present, is preferably equal to or 20 to 50% by weight of the sum of flux mixture composed of monopotassium tetrafluoroaluminate and compatibilizing compound and the filler metal or filler metal precursor. The content of alkali metal fluorosilicate can even be higher than 50% by weight.

The flux mixture may also contain metal salts which improve the brazing process or the surface qualities of the brazed parts as described in US 2007/0277908 and WO 2007/131993. For example, tin, lanthanum, cerium, bismuth, yttrium, zirconium or titanium compounds, especially the fluorides, or Li₃AlF₆, LiF and other Li salts, e.g. LiOH or Li₂CO₃, can be added. The content of such metal salts is preferably equal to or lower than 6% by weight, more preferably, equal to or lower than 5% by weight of the total weight of the dry flux mixture.

The flux mixture, optionally including additives like those described above, can be applied as such, as dry powder, for example, electrostatically or plasma assisted, e.g. by applying low temperature plasma.

Alternatively, it can be applied according to the wet fluxing method. In the wet fluxing method, a flux composition is applied which contains the flux mixture and further components. The flux composition may be applied by spraying, painting or printing onto at least one of the parts to be joined by brazing.

A flux composition for wet application which contains the flux mixture described above is another embodiment of the present invention. This flux composition (and thus also the method of brazing according to the present invention where the flux composition can be applied) will now be explained in detail.

The flux composition of the present invention contains the flux mixture suspended in water, water-free organic liquids or aqueous organic liquids. Preferred liquids are those that have a boiling point at ambient pressure (1 bar abs) of equal to or lower than 350° C. The term “suspended in water” does not exclude that a part of the flux composition is dissolved in the liquid; this may be the case especially when water or aqueous organic liquids are contained. Liquids that are preferred are deionized water, mono-, di- or tribasic aliphatic alcohols, especially those with 1 to 4 carbon atoms, e.g. methanol, ethanol, isopropanol, or ethylene glycol, or glycol alkyl ethers, wherein alkyl preferably denotes linear or branched aliphatic C1 to C4 alkyl. Non-limiting examples are glycol monoalkyl ethers, e.g. 2-methoxyethanol or diethylene glycole, or glycol dialkylethers, for example, dimethylglycol (dimethoxyethane).

In one preferred embodiment the flux mixture is present in the form of a flux composition wherein the flux mixture is suspended in a liquid which also contains a binder. Binders improve, for example, the adhesion of the flux mixture after their application on the parts to be brazed. Thus, the wet flux method using a flux composition comprising flux mixture, binder and water, organic liquid or aqueous organic liquid is a preferred embodiment of the brazing process of the present invention.

Suitable binders can be selected for example from the group consisting of organic polymers. Such polymers are physically drying (i.e., they form a solid coating after the liquid is removed), or they are chemically drying (they may form a solid coating e.g. under the influence of oxygen or light which causes a cross linking of the molecules), or both. Suitable polymers include polyolefines, e.g. butyl rubbers, polyurethanes, resins, phthalates, acrylates, methacrylates, vinyl resins, epoxy resins, nitrocellulose, polyvinyl acetates or polyvinyl alcohols. Flux compositions containing water as a liquid and water-soluble polymers, for example, polyurethane, are especially suitable because they have the advantage that, during the brazing process, water is evaporated instead of possibly flammable organic liquids.

The compositions may further include other additives which improve the properties of the composition, for example, suspension stabilizers e.g. xanthan gu or polyethylene glycol, surfactants, e.g. polyethylene glycol p-(1,1,3,3-tetramethylbutyl)-phenyl ether (available as Triton X®), Tetraoxo decanoic acid, Antarox BL225® (a mixture of ethoxylated propoxylated C8-C10 alcohols, available from Rhodia), thickeners, e.g. methyl butyl ether, or thixotropic agents, e.g. gelatine or pectines.

The content of the flux mixture (including filler metal, filler precursor, additives, e.g. metal salts, improving the brazing or surfaces properties) in the total composition (including liquid or liquids, thixotropic agents, surfactants and binders, if present) generally is equal to or greater than 0.75% by weight. Preferably, it is equal to or greater than 1% by weight. More preferably, the flux mixture content in the composition is equal to or greater than 5% by weight, very preferably, equal to or greater than 10% by weight of the total flux composition.

Generally, the flux mixture content in the composition is equal to or lower than 70% by weight. Preferably, it is equal to or lower than 50% by weight.

The binder, if present, is generally contained in an amount of equal to or greater than 0.1% by weight of the total flux composition. Preferably, if present, the binder is contained in an amount equal to or greater than 1% by weight of the total flux composition. The binder, if present, is generally contained in an amount equal to or lower than 30% by weight of the total composition. Preferably, if present, the binder is contained in an amount of equal to or lower than 25% by weight.

The thixotropic agent, if present, is generally contained in an amount of equal to or greater than 1% by weight of the total flux composition. Generally, if present, it is contained in an amount equal to or lower than 20% by weight. Preferably, if present, it is contained in an amount equal to or lower than 10% by weight of the total flux composition.

The thickener, if present, is generally contained in an amount of equal to or greater than 1% by weight of the total flux composition. Preferably, it is contained in an amount of equal to or greater than 5% by weight. Often, the thickener, if present, is contained in an amount of equal to or lower than 15% by weight of the total composition. The thickener, if present, preferably is contained in an amount equal to or lower than 10% by weight.

Highly suitable flux compositions for wet applications contain 10 to 70% by weight of the flux mixture (including filler metal, filler precursor, additives, e.g. metal salts, improving the brazing or surfaces properties), 1 to 25% by weight binder, 0 to 15% by weight of a thickener, 0 to 10% by weight of a thixotropic agent, and 0 to 5% by weight of a surfactant or suspension stabilizer, the reminder to 100% by weight being water, an organic solvent or an aqueous organic solvent.

In one specific embodiment, the flux composition is free of any water or water-free or aqueous organic liquid, but contains the flux mixture (optionally additives which improve the brazing process or the properties of the brazed product) as described above, and a water-soluble organic polymer as a binder which is present in the form of a soluble package for the flux. For example, polyvinyl alcohol is very suitable as water-soluble package for the flux mixture as described in US patent application publication 2006/0231162.

Dry flux mixtures can be applied according to known methods, for example, as mentioned above, electrostatically. Alternatively, they can be applied by the plasma method described in WO 2006/100054. In this process, finely divided flux powder is partially molten by a low temperature plasma beam and sprayed onto the surface of the aluminum parts to be joined.

The wet flux compositions can also be applied according to methods known in the art. For example, they can be sprayed onto the surface forming coated parts; they can be applied by immersing the aluminum parts to be brazed into the flux composition thus forming coated parts; by painting or printing the flux composition onto the aluminum parts to be brazed thus forming coated parts. It has to be kept in mind that the term “aluminum” includes aluminum alloys, especially magnesium containing alloys. The liquid-free flux composition containing flux mixture and water-soluble binder in form of a package can be put into water before use to form an aqueous flux composition containing suspended flux mixture and dissolved binder.

Generally, the parts coated with the wet flux composition are dried (this is of course not necessary in parts coated according to the dry method unless one applies fluoroaluminate hydrates and wants to remove crystal water before starting the brazing process).

For brazing, the coated parts to be joined by brazing are assembled (before or after drying if coated according to a wet process) and heated to provide an acceptable joint. Often, the assembled parts are heated to a temperature equal to or lower than 650° C., preferably, equal to or lower than 620° C. Preferably, they are heated to a temperature in a range of from about 560° C. to about 615° C. This can be done in an inert gas atmosphere, e.g. in a nitrogen or argon atmosphere.

The flux mixture and flux composition of the present invention are especially suitable to braze aluminum alloys containing magnesium, especially aluminum alloys containing equal to or more than 0.3% by weight of magnesium. They are suitable for aluminum alloys containing magnesium in an amount of equal to or lower than 1.5% by weight, and more preferably, for aluminum alloys containing magnesium in an amount of equal to or lower than 1.0% by weight. If desired, the flux mixtures and flux compositions can also be used for brazing magnesium-free aluminum parts.

Parts made from aluminum or aluminum alloys, coated by a flux mixture or a flux composition as described above are also an embodiment of the present invention.

Brazed parts prepared by brazing at least two parts made from aluminum or aluminum alloys wherein at least one part is a part coated by a flux mixture or a flux composition as described above are another embodiment of the present invention.

Should the disclosure of any patents, patent applications, and publications which are incorporated herein by reference conflict with the description of the present application to the extent that it may render a term unclear, the present description shall take precedence.

The following examples describe the invention in further detail without intending to limit the invention.

### EXAMPLES

### Example 1

### Brazing of Mg—Al alloy with 0.4% by weight of magnesium using KAlF₄ containing 2% Cs

KAlF₄ was mixed with CsAlF₄ so that a mixture resulted which contained 2% Cs (as CsAlF₄). Isopropanol was added to the mixture to provide a very homogenous mixture.

Aluminum parts in the form of coupons of an aluminum-magnesium alloy with 0.4% Mg, clad with a filler metal (AlSi4343), were coated with the suspension. The solvent was evaporated, and parts with flux loads of 5-7 g/m² were obtained. An aluminum angle was positioned onto the flux-loaded parts, and the resulting assembly was brought into a brazing oven. The oven was heated up with heat rates of 30° C./min. A brazed assembly was obtained which was completely brazed.

### Comparison Example 1

### Brazing of Mg—Al alloy with 0.4% by weight of magnesium using a KAlF₄/K₂AlF₅ mixture containing 2% Cs

A mixture of KAlF₄ (˜20%) and K₂AlF₅ (˜80%) was mixed with CsAlF₄ so that a mixture resulted which contained 2% Cs (as CsAlF₄). Isopropanol was added to the mixture to provide a very homogenous mixture.

Aluminum parts in the form of coupons of an aluminum-magnesium alloy with 0.4% Mg, clad with a filler metal (AlSi4343), were coated with the suspension. The solvent was evaporated, and parts loaded with flux were obtained. An aluminum angle was positioned onto the flux-loaded parts, and the resulting assembly was brought into a brazing oven. The oven was heated up with heat rates of 30° C./min. To obtain a brazed assembly which was completely brazed, flux loads of at least 10 g/m² were needed.

### Example 2

### Brazing of Mg—Al alloy with 0.8% by weight of magnesium using KAlF₄ containing 3% Cs

Example 1 was repeated, but this time, the amount of cesium fluoroaluminate mixed with KAlF₄ was such that KAlF₄ containing 3% Cs (as CsAlF₄) was obtained; and a magnesium-aluminum alloy was used which contained 0.8% by weight of magnesium. This time, the flux load was 10 g/m². The heat rates in the brazing oven again were 30° C./min. Once again, completely brazed parts were obtained.

### Example 3

### Brazing of Mg—Al alloy with 1% by weight of magnesium using KAlF₄ containing 3.5% Cs

Example 1 was repeated, but this time, a clad less magnesium-aluminum alloy plate containing 1% by weight of magnesium was used. The flux load this time was 15 g/m². An aluminum angle was positioned onto the plate, and the filler metal was added in the form of little rods (rod or piece of wire) to the contact of plate and angle (thus, no clad plate was used). Heating of the assembly was performed as in example 1.

Even with the loose pieces of filler metal (rods not plated onto the Al alloy part) which makes obtaining a good joint more difficult, a completely brazed part was obtained.

1. A flux mixture containing potassium fluoroaluminate and at least one magnesium-compatibilizing compound selected from the group consisting of metal fluorometallates with the proviso that potassium fluoroaluminate is essentially present as monopotassium tetrafluoroaluminate.

2. The flux mixture of claim 1 wherein the content of monopotassium tetrafluoroaluminate in the potassium fluoroaluminate, set as 100% by weight, is equal to or greater than 97% by weight.

3. The flux mixture of claim 1 wherein the content of monopotassium tetrafluoroaluminate is equal to or lower than 99% by weight and equal to or greater than 80% by weight, calculated on the total dry weight of the flux mixture.

4. The flux mixture of claim 1, wherein the metal fluorometallate is selected from the group consisting of cesium fluoroaluminates, potassium fluorozincates and cesium fluorozincates.

5. The flux mixture of claim 4 comprising cesium tetrafluoroaluminate as metal fluorometallate.

6. The flux mixture of claim 1 wherein the metal fluorometallate is contained in an amount of equal to or greater than 1% by weight, and equal to or lower than 20% by weight of the total dry weight of the flux mixture.

7. The flux mixture of claim 1, further comprising at least one additive selected from the group consisting of filler metal, filler metal precursor, and metal salts which improve the brazing process or the surface qualities of the brazed parts.

8. A flux composition comprising the flux mixture of claim 1 and a binder or a binder and a liquid selected from the group consisting of water, organic liquids and aqueous organic liquids.

9. The flux composition of claim 1 wherein the liquid is water, a C1 to C4 alcohol or a glycolmonoalkylether or a glycoldialkylether.

10. The flux composition of claim 8 wherein the binder is selected from the group of polymers consisting of polyolefines, polyurethanes, resins, phthalates, acrylates, methacrylates, vinyl resins, epoxy resins, nitrocellulose, polyvinyl acetates and polyvinyl alcohols.

11. The flux composition of claim 8 wherein the flux composition is free of any water or water-free or aqueous organic liquid, wherein the binder is selected from the group consisting of water-soluble organic polymers, and wherein the binder is arranged as a package for the flux.

12. A method of brazing parts made of aluminum or aluminum alloys, the method comprising assembling the parts in the presence of a flux mixture according to claim 1.

13. The method of claim 12 wherein parts made of magnesium-containing aluminum alloys are brazed, the magnesium-containing alloy comprising 0.3 to 1.5% by weight of magnesium.

14. A part made from aluminum or aluminum alloys, wherein the part is coated by a flux mixture according to claim 1.

15. A brazed part prepared by brazing at least two parts made from aluminum or aluminum alloys wherein at least one part is a part according to claim 14.

16. A method of brazing parts made of aluminum or aluminum alloys, the method comprising assembling the parts in the presence of a flux composition according to claim 8.

17. A part made from aluminum or aluminum alloys, wherein the part is coated by a flux composition according to claim 8.

18. A brazed part prepared by brazing at least two parts made from aluminum or aluminum alloys wherein at least one part is a part according to claim 17.
